(19) United States
(12) Patent Application Publication
(10) Pub. No.: US 2017/0203741 A1
(43) Pub. Date: Jul. 20, 2017

(54) WHEEL PRESSURE ESTIMATION APPARATUS AND METHOD OF ESTIMATING WHEEL PRESSURE

(71) Applicant: MANDO CORPORATION, Gyeonggi-do (KR)

(72) Inventor: Jin-Se Kim, Gyeonggi-do (KR)

(21) Appl. No.: 15/407,202

(22) Filed: Jan. 16, 2017

(30) Foreign Application Priority Data
Jan. 19, 2016 (KR) 10-2016-0006416

(51) Int. Cl. B60T 13/74; B60T 17/02

(52) U.S. Cl. CPC B60T 13/745; B60T 17/02; B60T 2270/88

(57) ABSTRACT

Wheel pressure estimation apparatus and method are disclosed. A wheel pressure estimation apparatus includes: an inputter configured to receive a brake signal output from an electronically controlled brake apparatus and receive a brake pedal signal detected from a detector and a pressure value of a master cylinder, an estimator configured to estimate a discharge flow rate of a motor pump generated by a suctioning operation of the motor pump to estimate a wheel pressure when the brake signal is received, a determiner configured to determine whether a driver intends to brake according to whether the brake pedal signal is input and a controller configured to control the estimator to estimate the wheel pressure again using discharge flow rate model information in which the pressure value of the master cylinder is applied to the discharge flow rate of the estimated motor pump, when the driver intends to brake.

### CROSS-REFERENCE TO RELATED APPLICATION

This application claims the benefit of Korean Patent Application No. 2016-0006416, filed on Jan. 19, 2016 in the Korean Intellectual Property Office, the disclosure of which is incorporated herein by reference.

### BACKGROUND

1. Field

Embodiments of the present disclosure relate to a wheel pressure estimation apparatus and a method of estimating a wheel pressure.

2. Description of the Related Art

Generally, when a driver steps on a brake pedal, a conventional brake apparatus is provided to transfer a hydraulic pressure formed in a master cylinder to a wheel cylinder provided in each wheel in order to generate a braking action which converts kinetic energy of each wheel to thermal energy so that a vehicle is decelerated or stopped.

Here, an electronically controlled brake apparatus has generally been applied to the conventional brake apparatus for the efficiency and reliability of braking.

Such a conventional electronically controlled brake apparatus estimates a discharge flow rate of a motor pump generated by a suctioning operation of the motor pump for brake and estimates a wheel pressure for the brake.

However, when a driver intends to brake for braking, the conventional electronically controlled brake apparatus has a problem in that the performance of controlling the brake is lowered because the performance of estimating the wheel pressure is decreased according to the performance of estimating the discharge flow rate of the motor pump.

Recently, when brake is performed by an electronically controlled brake apparatus and a driver intends to brake, research on an improved wheel pressure estimation apparatus capable of improving the performance of estimating wheel pressure and a method of estimating a wheel pressure is continually being conducted.

### SUMMARY

Therefore, it is an aspect of the present disclosure to provide a wheel pressure estimation apparatus capable of improving the performance of estimating wheel pressure and a method of estimating a wheel pressure when braking is performed by an electronically controlled brake apparatus and a driver intends to brake.

Additional aspects of the disclosure will be set forth in part in the description which follows and, in part, will be obvious from the description, or may be learned by practice of the disclosure.

In accordance with an aspect of the present invention, A wheel pressure estimation apparatus includes: an inputter configured to receive a brake signal output from an electronically controlled brake apparatus and receive a brake pedal signal detected from a detector and a pressure value of a master cylinder; an estimator configured to estimate a discharge flow rate of a motor pump generated by a suctioning operation of the motor pump to estimate a wheel pressure when the brake signal is received; a determiner configured to determine whether a driver intends to brake according to whether the brake pedal signal is input; and a controller configured to control the estimator to estimate the wheel pressure again using discharge flow rate model information in which the pressure value of the master cylinder is applied to the discharge flow rate of the estimated motor pump, when the driver intends to brake.

The discharge flow rate model information may include an accumulated discharge flow rate accumulated by integrating the discharge flow rate of the motor pump, to which the pressure value of the master cylinder is applied, for a predetermined time.

The discharge flow rate model information may include a discharge efficiency constant, a cross-section value of the motor pump, and revolutions per minute (RPM) of a motor to estimate the discharge flow rate of the motor pump and includes the pressure value of the master cylinder.

The discharge flow rate model information may include a discharge efficiency constant, a cross-section value of the motor pump, and a travel distance change rate of the motor pump for a predetermined time to estimate the discharge flow rate of the motor pump and includes the pressure value of the master cylinder.

The discharge flow rate model information may include a discharge efficiency constant, a volume change rate of the motor pump, and a revolution count of a motor to estimate the discharge flow rate of the motor pump and includes the pressure value of the master cylinder.

The discharge flow rate model information may include a discharge efficiency constant, a cross-section value of the motor pump, an eccentric value of a motor, and a rev count of the motor to estimate the discharge flow rate of the motor pump and includes the pressure value of the master cylinder.

In accordance with another aspect of the present invention, a method of estimating a wheel pressure includes: a first input operation of receiving a brake signal output from an electronically controlled brake apparatus; a first estimation operation of estimating a discharge flow rate of a motor pump generated by a suctioning operation the motor pump to estimate a wheel pressure when the brake signal is received; a determination operation of determining whether a driver intends to brake according to whether a brake pedal signal detected from a detector is input;

a second input operation of receiving a pressure value of a master cylinder detected from the detector, when the driver intends to brake; and a second estimation operation of estimating the wheel pressure again using discharge flow rate model information in which the pressure value of the master cylinder is applied to the discharge flow rate of the estimated motor pump, when the pressure value of the master cylinder is received.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating a state in which a wheel pressure estimation apparatus according to one embodiment of the present disclosure.

FIG. 2 is a block diagram illustrating an example of the wheel pressure estimation apparatus shown in FIG. 1.

FIG. 3A is a characteristic graph illustrating a value of a wheel pressure estimated by a wheel pressure estimation apparatus to which conventional discharge flow rate model information has not been applied.

FIG. 3B is a characteristic graph illustrating a value of a wheel pressure estimated by a wheel pressure estimation apparatus to which discharge flow rate model information according to one embodiment of the present disclosure has been applied.

FIG. 4A is a characteristic graph illustrating a time point at which a pressure of a master cylinder is applied through a hydraulic valve to control a pressure of a wheel using a conventional wheel pressure estimation apparatus.

FIG. 4B is a characteristic graph illustrating a time point at which a pressure of the master cylinder is applied through the hydraulic valve to control a pressure of the wheel using the wheel pressure estimation apparatus according to one embodiment of the present disclosure.

FIG. 5 is a flowchart illustrating a method of estimating a wheel pressure using the wheel pressure estimation apparatus according to one embodiment of the present disclosure.

### DETAILED DESCRIPTION

Hereinafter, embodiments of the present disclosure will be described in detail with reference to the accompanying drawings. The embodiments are provided in order to fully explain the spirit and scope of the present disclosure to those skilled in the art. Thus, the present disclosure is not to be construed as being limited to the embodiments set forth herein and may be accomplished in other various embodiments. Parts irrelevant to the description will be omitted in the drawings in order to clearly explain the present disclosure. Sizes of elements in the drawings may be exaggerated in order to facilitate understanding.

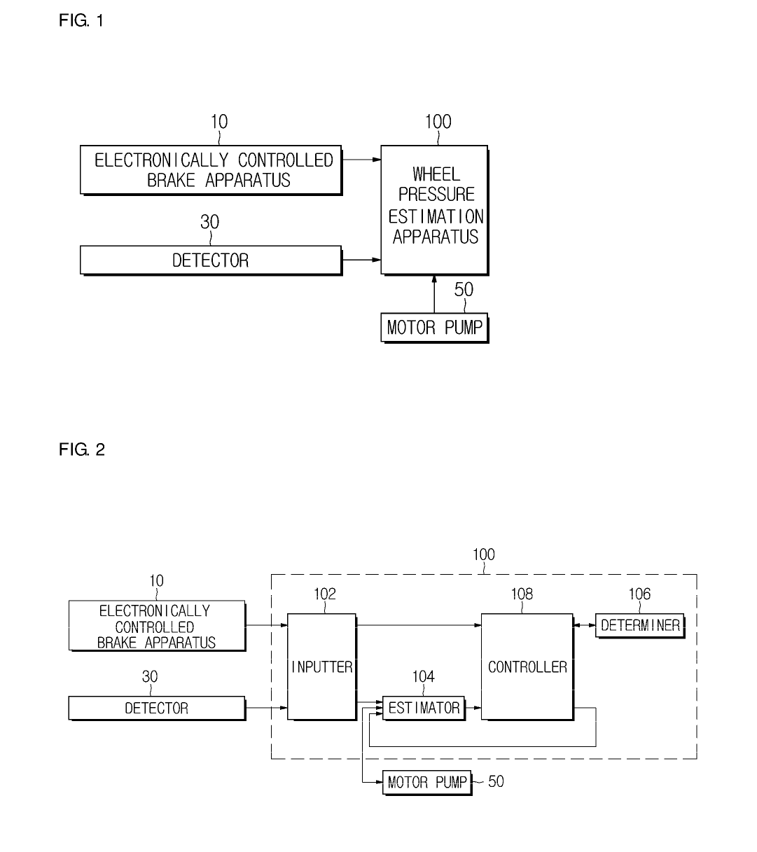

FIG. 1 is a block diagram illustrating a state in which a wheel pressure estimation apparatus according to one embodiment of the present disclosure is connected to an electronically controlled brake apparatus, a detector, and a motor pump, and FIG. 2 is a block diagram illustrating an example of the wheel pressure estimation apparatus shown in FIG. 1.

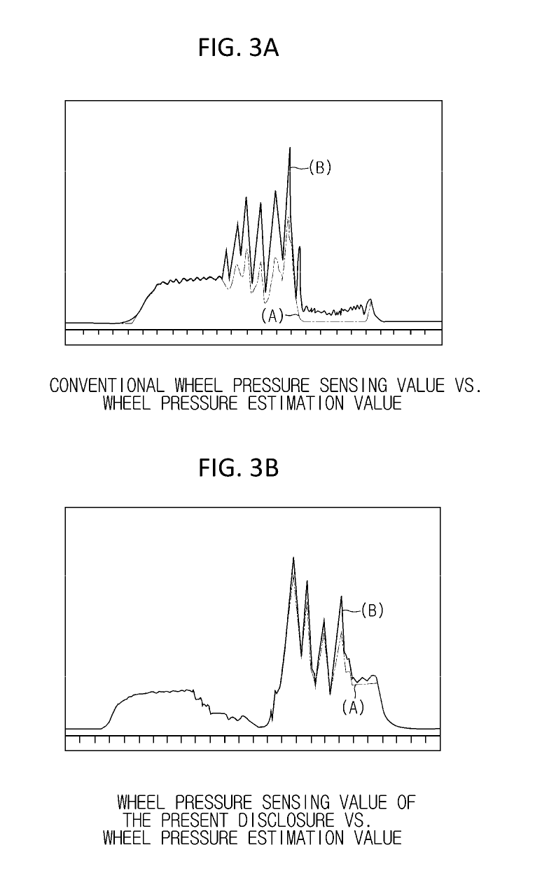

FIG. 3A is a characteristic graph illustrating a value of a wheel pressure estimated by a wheel pressure estimation apparatus to which conventional discharge flow rate model information has not been applied, and FIG. 3B is a characteristic graph illustrating a value of a wheel pressure estimated by a wheel pressure estimation apparatus to which discharge flow rate model information according to one embodiment of the present disclosure has been applied.

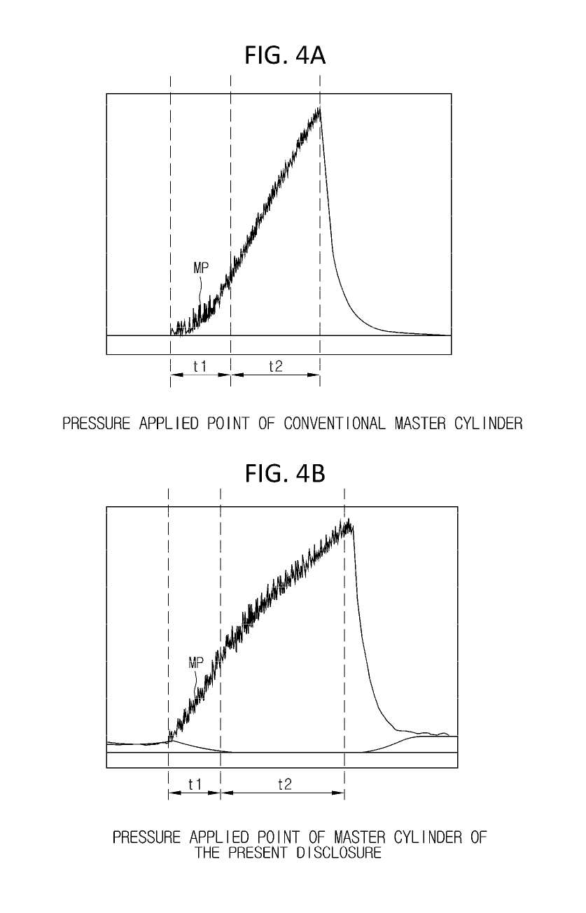

FIG. 4A is a characteristic graph illustrating a time point at which a pressure of a master cylinder is applied through a hydraulic valve to control a pressure of a wheel using a conventional wheel pressure estimation apparatus, and FIG. 4B is a characteristic graph illustrating a time point at which a pressure of the master cylinder is applied through the hydraulic valve to control a pressure of the wheel using the wheel pressure estimation apparatus according to one embodiment of the present disclosure.

Referring to FIGS. 1 to 4, a wheel pressure estimation apparatus 100 according to one embodiment of the present disclosure includes an inputter 102, an estimator 104, a determiner 106, and a controller 108.

The inputter 102 receives a brake signal output from the electronically controlled brake apparatus 10 and receives a brake pedal signal detected from a detector 30 and a pressure value of the master cylinder.

When the brake signal output from the inputter 102 is received, the estimator 104 estimates a discharge flow rate of a motor pump 50 generated by a suctioning operation of the motor pump 50 to estimate a wheel pressure.

The determiner 106 determines whether a driver intends to brake according to whether the brake pedal signal input from the inputter 102 is input, on the basis of controlling the controller 108 which will be described below.

When the determiner 106 determined that the driver had intended to brake, the controller 108 controls the estimator 104 to estimate the wheel pressure again using discharge flow rate model information in which the pressure value of the master cylinder is applied to the discharge flow rate of the motor pump 50 estimated from the estimator 104.

For example, the discharge flow rate model information may be expressed by Equations 1 to 3.

$$\begin{matrix}Q = α \cdot η \cdot A \cdot v = α \cdot η \cdot A \cdot \frac{Δ l}{Δ t} = α \cdot η \cdot Δ V \cdot ( \frac{N}{60} ) = α \cdot η \cdot A \cdot 2 e \cdot ( \frac{N}{60} ) & 〈 Equation 1 〉 \\ α = f ( {MasterCylinder}_{Pressure } ) & 〈 Equation 2 〉 \\ V = {\int }_{ }^{ } Q dt & 〈 Equation 3 〉\end{matrix}$$

Here, the discharge flow rate model information may include an accumulated discharge flow rate V accumulated by integrating the discharge flow rate Q of the motor pump 50 to which the pressure value α of the master cylinder is applied for a predetermined time.

Here, the discharge flow rate model information may include a discharge efficiency constant η, a cross-section value A of the motor pump 50, and revolutions per minute (RPM) V of a motor to estimate the discharge flow rate Q of the motor pump 50 and include the pressure value α of the master cylinder.

In addition, the discharge flow rate model information may include the discharge efficiency constant η, the cross-section value A of the motor pump 50, and a travel distance change rate

$$\frac{Δ l}{Δ f}$$

of the motor pump 50 for a predetermined time to estimate the discharge flow rate Q of the motor pump 50 and include the pressure value α of the master cylinder.

Further, the discharge flow rate model information may include the charge efficiency constant η, a volume change rate ΔV of the motor pump 50, and a rev count N of the motor to estimate the discharge flow rate Q of the motor pump 50 and include the pressure value α of the master cylinder.

Furthermore, the discharge flow rate model information may include the discharge efficiency constant η, the cross-section value A of the motor pump 50, an eccentric value 2e of the motor, and the rev count N of the motor to estimate the discharge flow rate Q of the motor pump 50 and include the pressure value α of the master cylinder.

As shown in FIG. 3B, a characteristic graph is shown, in which a wheel pressure estimation value A is equal to a wheel pressure sensing value B, which is output from the wheel pressure estimation apparatus 100 to which the discharge flow rate model information of the embodiment of the present disclosure has been applied.

That is, as shown in FIG. 3A, a characteristic graph is shown, in which a wheel pressure estimation value A is different from a wheel pressure sensing value B, which is output from a conventional wheel pressure estimation apparatus to which the discharge flow rate model information has not been applied.

Further, as shown in FIG. 4B, in order to control a wheel pressure using the wheel pressure estimation apparatus 100 to which the discharge flow rate model information of the embodiment of the present disclosure has been applied, it shows that a point, at which a pressure MP of the master cylinder is applied through the hydraulic valve, is gradually increased from an initially applied point t1 to an intermediately applied point t2.

That is, as shown in FIG. 4A, in order to control a wheel pressure using the conventional wheel pressure estimation apparatus to which the discharge flow rate model information has not been applied, it shows that a time point, at which a pressure MP of the master cylinder is applied through the hydraulic valve, is increased at only an initially applied point t1 and is gradually decreased toward an intermediately applied point t2.

Here, although the inputter 102, the estimator 104, the determiner 106, and the controller 108 are not shown, they may be provided to a general electric control unit (ECU) (not shown) which is a main computer applied to a vehicle and which controls, determines, inputs overall operations thereof and estimates the discharge flow rate of the motor pump 50.

In addition, the inputter 102, the estimator 104, the determiner 106, and the controller 108 may be provided to a general micro control unit (MCU) (not shown) which has a processor, a memory, and an input/output device as a single chip and which controls, determines, and inputs overall operations thereof and estimate the discharge flow rate of the motor pump 50.

Further, the inputter 102, the estimator 104, the determiner 106, and the controller 108 are not limited to being provided to the above and may be provided to all of controllers, determiners, inputters, and estimators which may control, determine, and input an overall operation of a vehicle and estimate the discharge flow rate of the motor pump 50.

Here, the inputter 102, the estimator 104, the determiner 106, and the controller 108 in an integrated type may be provided to an ECU or MCU, or each of the inputter 102, the estimator 104, the determiner 106, and the controller 108 may be provided to an ECU or MCU.

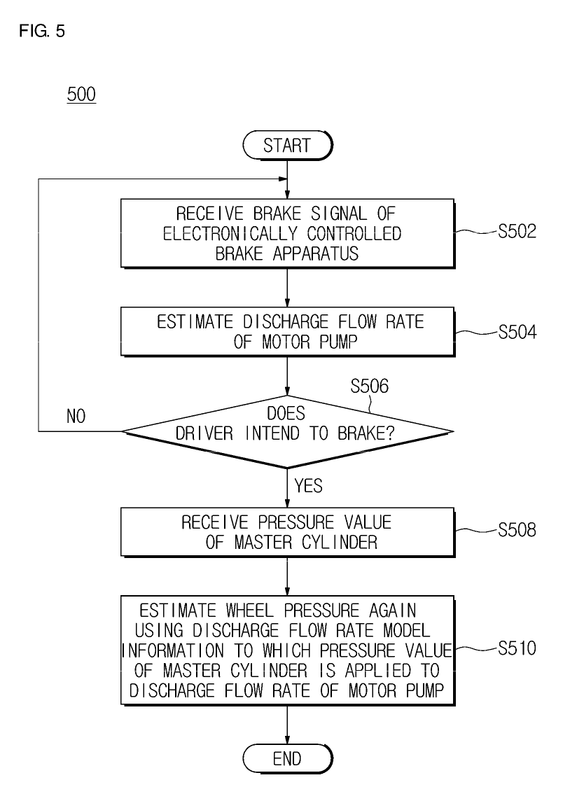

A method of estimating a wheel pressure using the wheel pressure estimation apparatus 100 according to one embodiment of the present disclosure will be described with reference to FIG. 5 below.

FIG. 5 is a flowchart illustrating a method of estimating a wheel pressure using the wheel pressure estimation apparatus according to one embodiment of the present disclosure.

Referring to FIG. 5, a method 500 of estimating a wheel pressure using the wheel pressure estimation apparatus 100 (see FIG. 2) according to one embodiment of the present disclosure includes a first input operation (S502), a first estimation operation (S504), a determination operation (S506), a second input operation (S508), and a second estimation operation (S510).

First, in the first input operation (S502), the inputter 102 (see FIG. 2) receives a brake signal output from the electronically controlled brake apparatus 10 (see FIG. 2).

Then, in the first estimation operation (S504), when the estimator 104 (see FIG. 2) receives the brake signal output from the inputter 102 (see FIG. 2), the estimator 104 (see FIG. 2) estimates a discharge flow rate of the motor pump 50 (see FIG. 2) generated by a suctioning operation of the motor pump 50 (see FIG. 2) to estimate a wheel pressure.

Then, in the determination operation (S506), the determiner 106 (see FIG. 2) determines whether a driver intends to brake according to whether a brake pedal signal detected from the detector 30 (see FIG. 2) input from the inputter 102 (see FIG. 2) is input, on the basis of a control of the controller 108 (see FIG. 2).

Then, in second input operation (S508), when the determiner 106 (see FIG. 2) determined that the driver had intended to brake, the inputter 102 (see FIG. 2) receives a pressure value of a master cylinder detected from the detector 30 (see FIG. 2).

Then, in the second estimation operation (S510), when the controller 108 (see FIG. 2) receives the pressure value of the master cylinder output from the inputter 102 (see FIG. 2), the controller 108 (see FIG. 2) controls the estimator 104 (see FIG. 2) to estimate the wheel pressure again using discharge flow rate model information to which the pressure value of the master cylinder has been applied to the discharge flow rate of the motor pump 50 (see FIG. 2) estimated from the estimator 104 (see FIG. 2).

Here, the discharge flow rate model information may include an accumulated discharge flow rate accumulated by integrating the discharge flow rate of the motor pump 50 (see FIG. 2), to which the pressure value of the master cylinder has been applied, for a predetermined time.

The wheel pressure estimation apparatus 100 according to one embodiment of the present disclosure includes the inputter 102, the estimator 104, the determiner 106, and the controller 108, and the method 500 of estimating a wheel pressure performs the first input operation (S502), the first estimation operation (S504), the determination operation (S506), the second input operation (S508), and the second estimation operation (S510).

Therefore, the wheel pressure estimation apparatus 100 and the method 500 of estimating a wheel pressure according to one embodiment of the present disclosure can improve performance of estimating a wheel pressure, when braking is performed by an electronically controlled brake apparatus 10 and a driver intends to brake.

As is apparent from the above description, a wheel pressure estimation apparatus and a method of estimating wheel pressure according to embodiments of the present disclosure can improve performance of estimating a wheel pressure, when braking is performed by an electronically controlled brake apparatus and a driver intends to brake.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A wheel pressure estimation apparatus comprising:
an inputter configured to receive a brake signal output from an electronically controlled brake apparatus and receive a brake pedal signal detected from a detector and a pressure value of a master cylinder;
an estimator configured to estimate a discharge flow rate of a motor pump generated by a suctioning operation of the motor pump to estimate a wheel pressure when the brake signal is received;
a determiner configured to determine whether a driver intends to brake according to whether the brake pedal signal is input; and
a controller configured to control the estimator to estimate the wheel pressure again using discharge flow rate model information in which the pressure value of the master cylinder is applied to the discharge flow rate of the estimated motor pump, when the driver intends to brake.

2. The wheel pressure estimation apparatus of claim 1, wherein the discharge flow rate model information includes an accumulated discharge flow rate accumulated by integrating the discharge flow rate of the motor pump, to which the pressure value of the master cylinder is applied, for a predetermined time.

3. The wheel pressure estimation apparatus of claim 1, wherein the discharge flow rate model information includes a discharge efficiency constant, a cross-section value of the motor pump, and revolutions per minute (RPM) of a motor to estimate the discharge flow rate of the motor pump and includes the pressure value of the master cylinder.

4. The wheel pressure estimation apparatus of claim 1, wherein the discharge flow rate model information includes a discharge efficiency constant, a cross-section value of the motor pump, and a travel distance change rate of the motor pump for a predetermined time to estimate the discharge flow rate of the motor pump and includes the pressure value of the master cylinder.

5. The wheel pressure estimation apparatus of claim 1, wherein the discharge flow rate model information includes a discharge efficiency constant, a volume change rate of the motor pump, and a revolution count of a motor to estimate the discharge flow rate of the motor pump and includes the pressure value of the master cylinder.

6. The wheel pressure estimation apparatus of claim 1, wherein the discharge flow rate model information includes a discharge efficiency constant, a cross-section value of the motor pump, an eccentric value of a motor, and a rev count of the motor to estimate the discharge flow rate of the motor pump and includes the pressure value of the master cylinder.

7. A method of estimating a wheel pressure comprising:
a first input operation of receiving a brake signal output from an electronically controlled brake apparatus;
a first estimation operation of estimating a discharge flow rate of a motor pump generated by a suctioning operation the motor pump to estimate a wheel pressure when the brake signal is received;
a determination operation of determining whether a driver intends to brake according to whether a brake pedal signal detected from a detector is input;
a second input operation of receiving a pressure value of a master cylinder detected from the detector, when the driver intends to brake; and
a second estimation operation of estimating the wheel pressure again using discharge flow rate model information in which the pressure value of the master cylinder is applied to the discharge flow rate of the estimated motor pump, when the pressure value of the master cylinder is received.
